(19) United States
(12) Patent Application Publication
(10) Pub. No.: US 2009/0077327 A1
(43) Pub. Date: Mar. 19, 2009

(54) Method and apparatus for enabling a NAS system to utilize thin provisioning

(76) Inventor: Junichi HARA, San Jose, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/898,947

(22) Filed: Sep. 18, 2007

(51) Int. Cl. G06F 12/00

(52) U.S. Cl. 711/154

(57) ABSTRACT

A NAS (network attached storage) controller managing file system data is configured for use in a storage system having thin provisioning capability. Physical storage capacity is used efficiently by making it possible for the NAS controller to identify to a disk array system having thin provisioning capability which segments of a thin provisioned volume are no longer in use. File system blocks or block groups no longer in use by the NAS controller are identified by the NAS controller. The NAS controller sends a release request to the disk array system specifying thin provisioning segments that correspond to the identified FS blocks or block groups. The release request instructs the disk array system to release chunks of physical storage capacity assigned to the specified thin provisioning segments so that the physical storage capacity can be made available for reuse in the disk array storage system.

### BACKGROUND OF THE INVENTION

1. Field of the Invention

The present invention relates generally to computer information systems and storage systems for storing data.

2. Description of Related Art

According to recent trends in storage systems, disk array systems have emerged having a capability known as “thin provisioning”. These disk array systems provide virtual or “thin provisioned” volumes (TPVs) for block-based storage in an allocation-on-use fashion. In thin provisioning systems, the disk array system allocates actual (i.e., physical) disk space to the thin provisioned volumes “on demand” as the capacity of the volume is used. Initially, a thin-provisioned volume might not have any actual disk space allocated for storing data. When a write request is received that targets a portion of the thin-provisioned volume, the storage system allocates actual disk space for use as that portion of the volume. Then, the storage system stores the write data to the newly-allocated physical capacity that is designated for the targeted portion of the volume. In this manner, a volume of very large size can be virtually allocated for use by a user, and appear to the user as a storage resource having a very large size, while in fact, the only amount of physical capacity that has been allocated is the amount that is actually being used, thereby making efficient use of storage resources.

In other trends, Network Attached Storage (NAS) systems are well known in the storage industry. NAS systems provide a capability for sharing files among multiple host computers through a network. Therefore, a NAS system includes a file server capability and a file system capability to manage files within the system. Some NAS systems have disk array systems included within their enclosures, while other NAS systems only provide file server and file system capabilities (usually referred to as a NAS gateway or a NAS head). The latter type of NAS systems require separate disk array systems to be connected externally. The file system module on a NAS system is a software module that typically manages files using two kinds of data: metadata and file data. Metadata contains data attributes, such as names of the files and locations of actual data of the files within volumes. File data itself, on the other hand, is the actual data content of the file.

Because conventional disk array systems provide volumes which have actual disk space allocated, the file system on a NAS system does not actually delete file data from the disk array system when the file is deleted from the file system. In other words, even when a NAS system receives a request for deleting a file, the NAS system only deletes the metadata of the file. Therefore, under conventional technology, if a disk array system having thin provisioning capability is used in conjunction with a NAS system, there will remain physical disk space that is allocated and not used when a file is deleted, thereby wasting capacity in the thin provisioning storage system. Accordingly, there is a need for a method and apparatus that enables efficient use a of a NAS system with a thin provisioning system. Related art includes US Pat. Appl. Pub. No. 2004/0162958, to Kano et al., entitled “Automated On-line Capacity Expansion Method for Storage Device”, the entire disclosure of which is incorporated herein by reference.

### BRIEF SUMMARY OF THE INVENTION

The invention makes efficient use of physical disk space in an arrangement in which a disk array system having thin provisioning capability is used in conjunction with a NAS system. Physical disk capacity that is allocated but not used is able to be released and made available for use. These and other features and advantages of the present invention will become apparent to those of ordinary skill in the art in view of the following detailed description of the preferred embodiments.

### BRIEF DESCRIPTION OF THE DRAWINGS

The accompanying drawings, in conjunction with the general description given above, and the detailed description of the preferred embodiments given below, serve to illustrate and explain the principles of the preferred embodiments of the best mode of the invention presently contemplated.

FIG. 1 illustrates an example of a hardware configuration in which the method and apparatus of the invention may be applied.

FIG. 2 illustrates an example of a logical and software configuration of the invention applied to the architecture of FIG. 1.

FIG. 3 illustrates an example of mapping between thin provisioned volumes and pool volumes.

FIG. 4 illustrates an exemplary data structure of a thin provisioned volume management table.

FIG. 5 illustrates an exemplary data structure of a pool management table.

FIG. 6 illustrates an exemplary data layout of a file system.

FIG. 7 illustrates an exemplary data structure of inode information.

FIG. 8 illustrates an exemplary logical structure of a file system.

FIG. 9 illustrates an exemplary process for file system initialization.

FIG. 10 illustrates an exemplary alignment between file system data blocks and thin provisioned volume segments for the first embodiment of the invention.

FIG. 11 illustrates an exemplary procedure for file deletion.

FIG. 12 illustrates an exemplary data structure of a SCSI write command that can be used as a release command.

FIG. 13 illustrates an exemplary data layout for a file system according to a second embodiment of the invention.

FIG. 14 illustrates an exemplary alignment between file system data blocks and thin provisioned volume segments according to the second embodiment.

FIG. 15 illustrates an exemplary procedure of selecting and changing allocation status of data blocks in the second embodiment.

FIG. 16 illustrates an exemplary procedure of releasing unused segments in the second embodiment.

FIG. 17 illustrates an exemplary data layout of a file system according to a third embodiment of the invention.

FIG. 18 illustrates an exemplary alignment between file system block groups and thin provisioned volume segments according to the third embodiment of the invention.

FIG. 19 illustrates an exemplary process for file system initialization according to the third embodiment of the invention.

FIG. 20 illustrates an exemplary procedure of resource selection in the third embodiment.

FIG. 21 illustrates an exemplary procedure for release of chunks in the third embodiment.

### DETAILED DESCRIPTION OF THE INVENTION

In the following detailed description of the invention, reference is made to the accompanying drawings which form a part of the disclosure, and, in which are shown by way of illustration, and not of limitation, specific embodiments by which the invention may be practiced. In the drawings, like numerals describe substantially similar components throughout the several views. Further, the drawings, the foregoing discussion, and following description are exemplary and explanatory only, and are not intended to limit the scope of the invention or this application in any manner.

Embodiments of the invention disclose a system comprising a NAS controller, such as a NAS head, and a disk array system having thin provisioning capability. The NAS controller manages the locations where actual disk spaces are allocated. When certain disk spaces are no longer in use, the NAS controller is able to determine this and identify those disk spaces to the disk array system. In response, the disk array system releases the disk spaces identified as no longer being in use.

### FIRST EMBODIMENT

### System Configuration

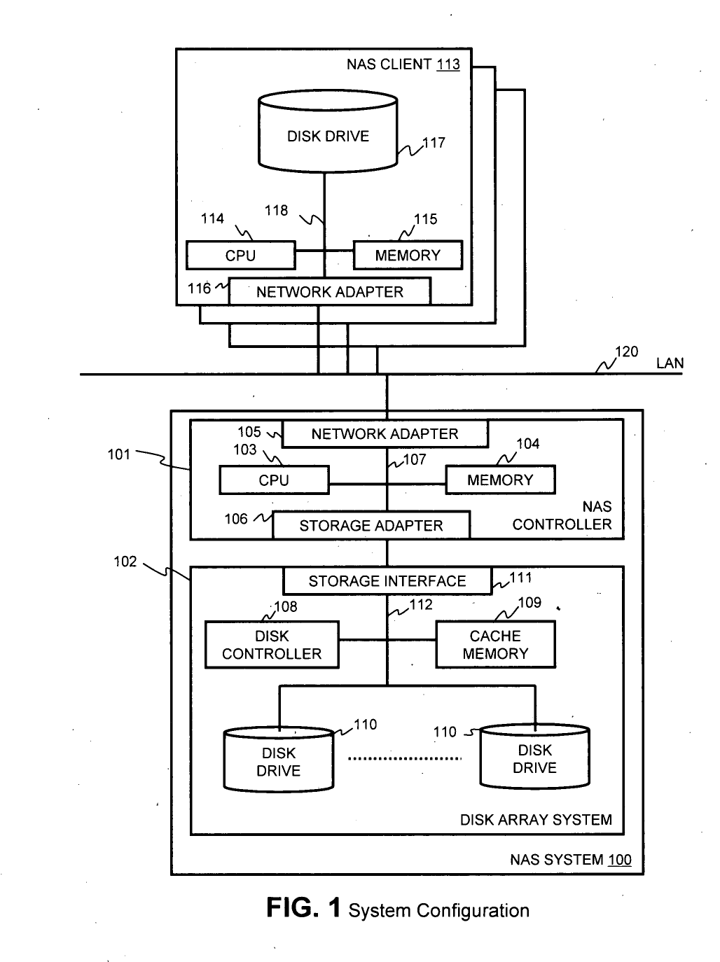

FIG. 1 illustrates an example of a configuration of an information system in which embodiments of the invention may be applied. The information system of FIG. 1 includes a NAS system 100 and one or more NAS clients 113 in communication via a network 120. NAS system 100 includes a NAS controller 101 and a disk array system 102. NAS controller 101 includes a CPU 103, a memory 104, a network adapter 105, and a storage adapter 106 connected to each other via a bus 107.

Disk array system 102 includes a disk controller 108, a cache memory 109, a storage interface 111, and one or more storage devices, such as hard disk drives 110 or other storage mediums. These components are connected to each other via a bus 112, or the like. Further, while disk drives are illustrated in the preferred embodiment, the storage devices may alternatively be solid state storage devices, optical storage devices, or the like. NAS controller 101 and disk array system 102 are connected to each other via storage adapter 106 and storage interface 111. Interfaces such as Fibre Channel (FC) or SCSI (Small Computer System Interface) can be used for storage interface 111. In those embodiments, a host bus adapter (HBA) is used for storage adapter 106. In other embodiments, storage adapter 106 and storage interface 111 may communicate via a direct communications link, Ethernet, or the like. Also, disk array system 102 can be externally deployed from NAS controller 101 and connected for communication over a network with NAS controller 101 via storage interface 111, in which case NAS controller 101 can be a NAS head and disk array system can be an external storage system.

Each of NAS clients 113 includes a CPU 114, a memory 115, a network adapter 116, and a storage device, such as a disk drive 117. Each of NAS clients 113 is connected for communication to network 120, which may be a local area network (LAN), via network adapter 116, and is thereby able to communicate with NAS system 100 by connection with network adapter 105 through network 120. The programs realizing the present invention may be stored on computer readable mediums and some of these programs may be executed on NAS controller 101 using CPU 103, and some on disk array system 102 using disk controller 108, as will also be described below.

Logical Configuration

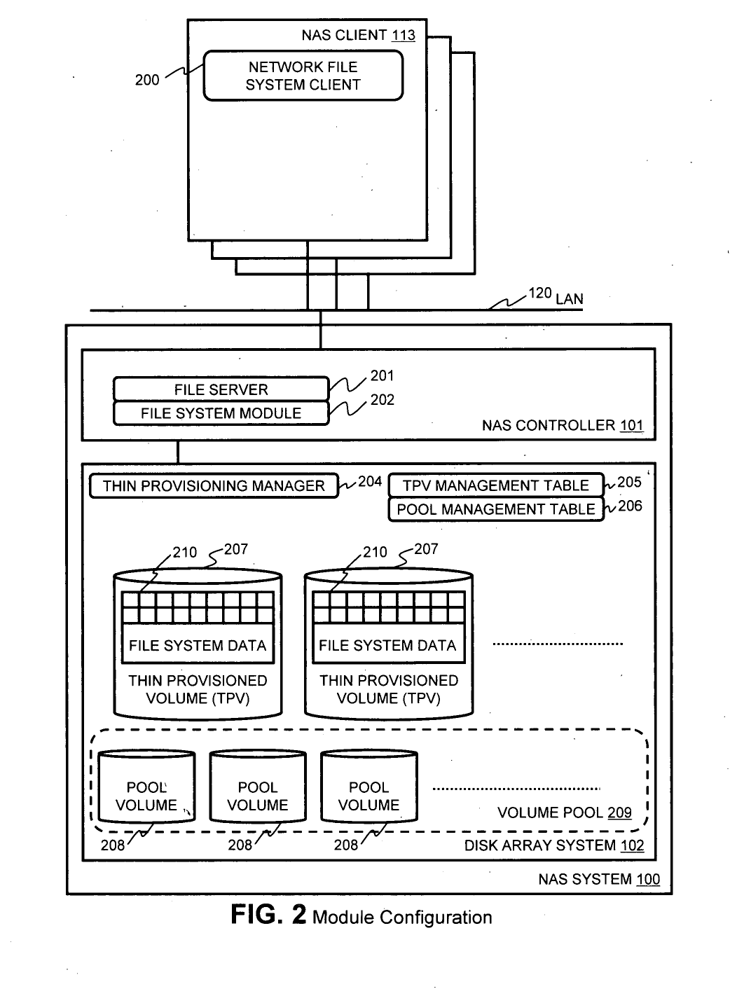

FIG. 2 illustrates an example of logical diagram for some embodiments of the present invention, based on the system illustrated in FIG. 1. In FIG. 2, each NAS client 113 may include a network file system client 200 that performs I/O (input/output) operations directed to NAS system 100. NAS controller 101 in NAS system 100 includes a file server 201 and a file system module 202. File server 201 is a module that exports files (i.e., makes the files accessible to the NAS clients) via a network file sharing protocol, such as NFS (Network File System), CIFS (Common Internet File System), or the like.

Network file system client 200 sends appropriate file I/O requests via the network file sharing protocol, such as NFS and CIFS, to NAS system 100 in response to instructions from users or applications on NAS client 113. File server module 201 interprets the I/O requests from NAS clients 113, issues appropriate file I/O requests to file system module 202, and sends back responses to NAS clients 113. File system module 202 receives file I/O requests from file server 201, and issues appropriate I/O requests to disk array system 102. Also, as will be discussed additionally below, file system module 202 manages which portion of a volume has actual disk space (i.e., which portion of a volume has actual disk space allocated by disk array system 102). When a portion of a volume is no longer needed for storage of files by file system module 202, then file system module 202 informs disk array system 102 of this.

In disk array system 102, there is included a thin provisioning manager 204, a thin provisioned volume management table 205, and a pool management table 206. Thin provisioning manager 204 creates and exports thin provisioned volumes (TPVs) 207, which are configured to include file system data 210. When a write I/O request arrives targeting a portion of a TPV 207, thin provisioning manager 204 checks whether actual disk space is already allocated for that portion of the TPV 207. If actual disk space is not yet allocated to that portion, thin provisioning manager 204 carves out an area of physical storage capacity (i.e., a chunk of physical storage) from pool volumes 208, and allocates the chunk 301 to the targeted portion (i.e., a segment) of the TPV 207. Pool volumes 208 may be conventional logical volumes that are created from allocated physical disk space on the storage devices 110, and may be maintained in a volume pool 209. The pool volumes are divided into chunks 301 of a predetermined uniform size, so that chunks can be used interchangeably with each other when being assigned to segments in a thin provisioned volume. Details of the thin provisioning allocation process are also described below.

Thin Provisioning

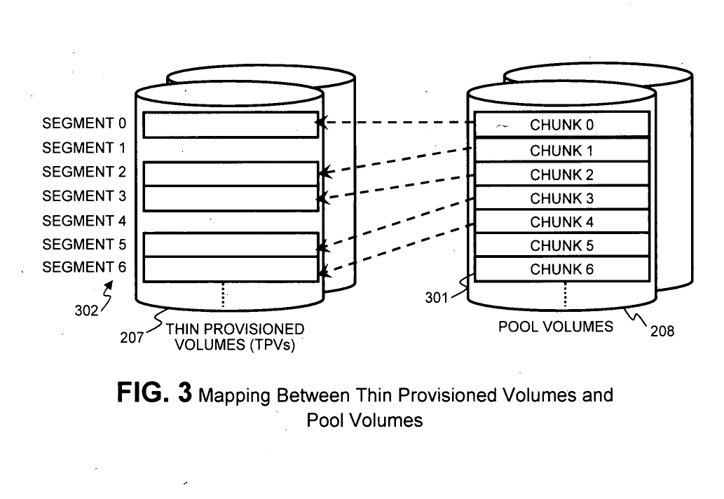

FIG. 3 illustrates an overview of how thin provisioning manager 204 manages the mapping between TPVs 207 and pool volumes 208. TPVs 207 start out essentially as virtual volumes that have no actual physical capacity allocated to them, although they appear to have a large capacity, such as a large number of logical block addresses. Disk array system 102 is able to provide one or more pool volumes 208 which may be conventional logical volumes that are configured from physical storage space on one or more storage devices 110 in disk array system 102. Thin provisioning manager 102 divides the pool volumes 208 into a number of fixed-length physical storage areas (chunks 301). One of these chunks 301 is assigned by thin provisioning manager 102 to a segment 302 of a TPV 207 when data is received that targets the particular segment of TPV 207. A TPV 207 consists of multiple virtual segments 302, and chunks 301 are allocated from one or more of pool volumes 208 and assigned to particular segments 302 of TPV 207 as needed. As an example, FIG. 3 illustrates that chunk 0 is assigned to segment 0, chunk 1 to segment 2, chunk 2 to segment 3, chunk 3 to segment 5, and chunk 4 to segment 6. Segments 1 and 4 have not yet had data stored thereto, and therefore no chunks have yet been assigned to these segments. Further, it should be noted that in the example illustrated, segment size (for example, number of bytes) is equal to chunk size for each segment and chunk; however, in other embodiments, this may not be the case in other thin provisioning schemes. Thus, the invention is not limited to particular chunk and segment size relations.

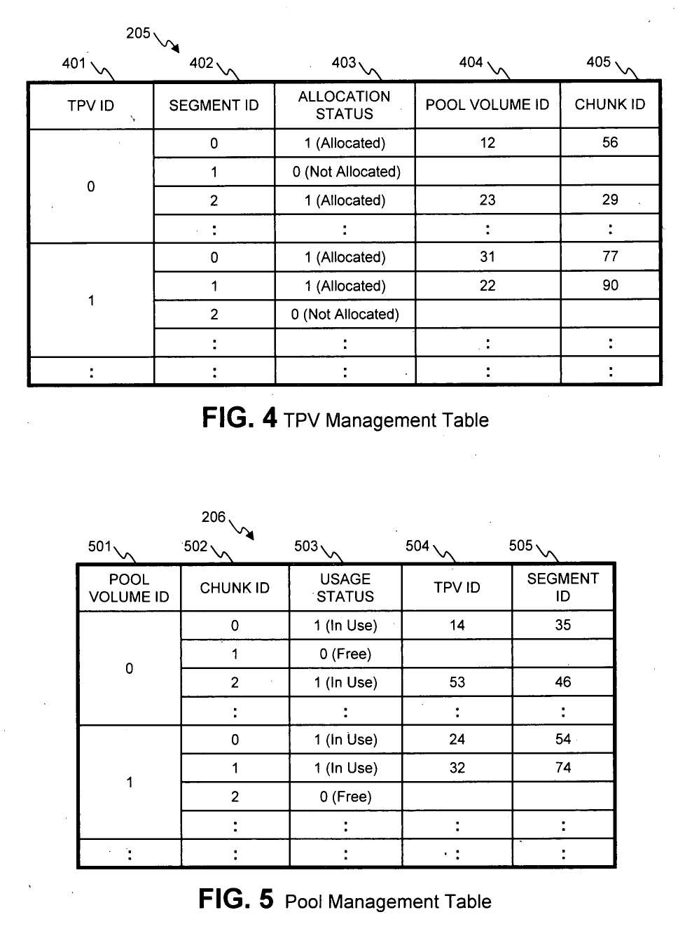

To manage the mapping between chunks 301 and segments 302, thin provisioning manager 102 uses TPV management table 205 and pool management table 206. FIG. 4 illustrates an exemplary data structure of TPV management table 205, which includes a TPV identifier (ID) entry 401 that contains an ID for each TPV 207. A segment ID entry 402 contains the ID for each segment within the TPV 207. An allocation status field 403 indicates if a chunk 301 is currently assigned to the segment 302. For example, a “1” can be used indicate that a chunk is assigned to the particular segment, and a “0” can be used to indicate that a chunk is not currently assigned to the segment 302. Other indicators may also be used. A pool volume ID field 404 indicates to which pool volume 208 the assigned chunk 301 belongs. This field is filled only when a chunk 301 is currently assigned to the segment 302. A chunk ID entry 405 indicates the ID of the chunk 301 assigned to the segment 302. This field is filled only when a chunk 301 is currently assigned to the segment 302.

FIG. 5 illustrates an exemplary data structure of pool management table 206, which includes a pool volume ID entry 501 which contains the ID for each pool volume 208. A chunk ID field 502 contains the ID for each chunk 301 within each pool volume 501. A usage status field 503 indicates if the particular chunk is currently used (i.e., assigned to a particular segment) or not. For example, a “1” entered in this field may be used to indicate that the chunk 301 is assigned to a segment 302, and “0” entered in this field may be used to indicate that the chunk 301 is not currently assigned to any segment. A TPV ID field 504 indicates the ID of the TPV 207 to which the chunk 301 is assigned. This field is filled only when the particular chunk 301 is currently assigned to a segment 302. A segment ID field 505 indicates the ID of the segment 302 to which the chunk 301 is assigned. This field is also filled only when the particular chunk 301 is currently assigned to a segment 302.

File System Data Structure:

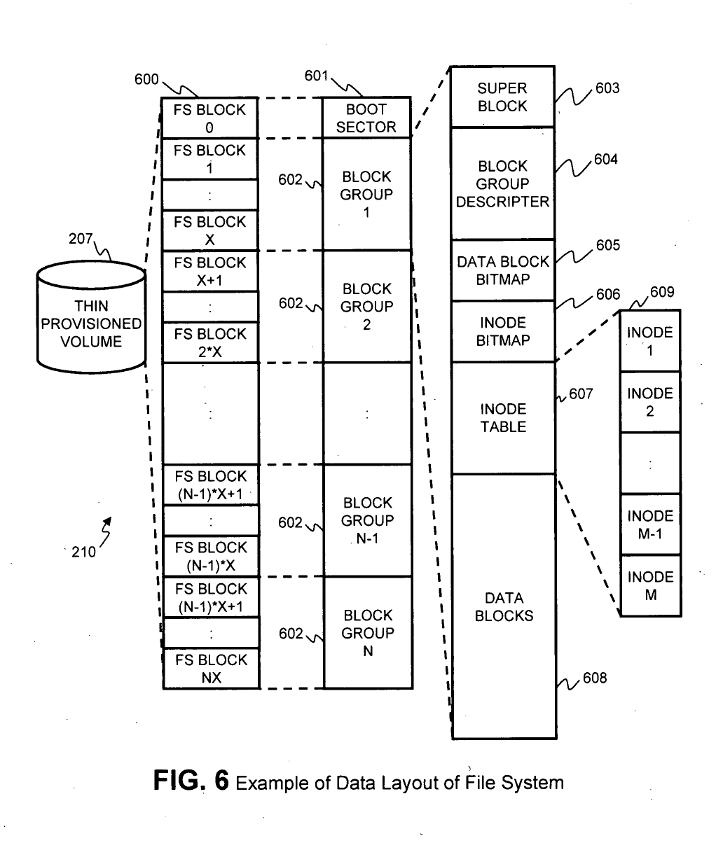

FIG. 6 illustrates an example of a data structure layout of the file system data 210 contained in a thin provisioned volume 207 according to the first embodiment of the invention. File system data 210 is created and managed by file system module 202 to manage files and directories in each TPV 207. File system module 202 divides a TPV 207 into blocks (file system (FS) blocks 600), and file system module 202 uses the volume based on the units of FS blocks 600.

The first FS block 600 (FS block 0) is used for a boot sector 601. Boot sector 601 is used to store programs used for booting up the system, if needed. File system module 202 does not change the data in boot sector 601. File system module 202 groups the rest of the FS blocks 600 into block groups 602. Each block group 602 is further divided into a plurality of regions that include a super block 603, a block group descriptor 604, a data block bitmap 605, an inode bitmap 606, an inode table 607 and data blocks 608. Each of these regions 603-608 is made up of one or more FS blocks 600 within the particular block group 602.

Super block 603 is provided in each block group 602, and used to store the location information of block groups 602. Thus, every block group 602 has the same copy of super block 603. In some embodiments, only first several block groups 602 may have the same copy of super block 603. Block group descriptor 604 stores the management information of the block group 602. Data block bitmap 605 illustrates which data blocks 608 are in use. Each bit in the data block bitmap 605 corresponds to each data block 608 in that block group 602 (for example, the third bit in the data block bitmap 605 corresponds to the third data block in the particular block group), and each bit represents usage of the data block (for example, a “0” indicates the data block is “free”, and a “1” indicates the data block is “in use”). In a similar manner, inode bitmap 606 illustrates which inodes 609 in inode table 607 are in use.

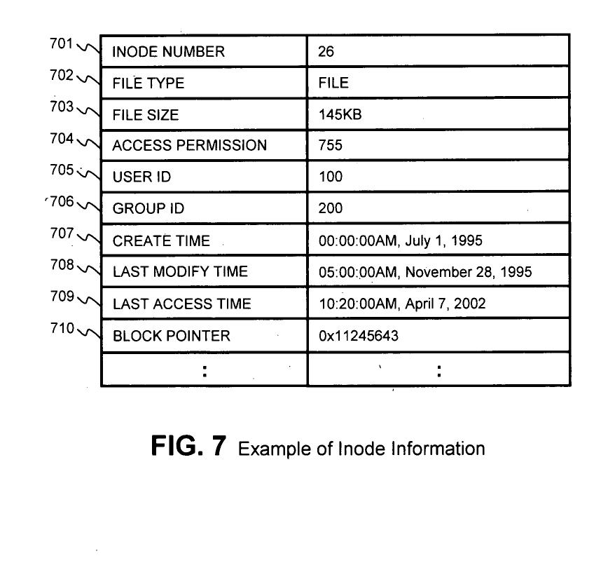

FIG. 7 illustrates an exemplary data structure showing the kind of data contained in each inode 609 in inode table 607. Each inode 609 stores attributes of each file or directory such as inode number 701, which is the unique number for the inode; file type 702 which is what the inode is used for (i.e., a file, a directory, etc.); file size 703, which is the size of the file or directory; access permission 704, which is a bit string expressing access permissions for a user (i.e., owner), a group, or other user; a user ID 705, which is an ID number of the user owning the file; a group ID 706, which is an ID number of the group that the user (the owner) belongs to; a create time 707, which is the time when the file or directory was created; last modify time 708, which is the time when the file or directory was last modified; last access time 709, which is the time when the file or directory was last accessed; and a block pointer 710, which is a pointer to the data blocks where the actual data of the file or directory is stored.

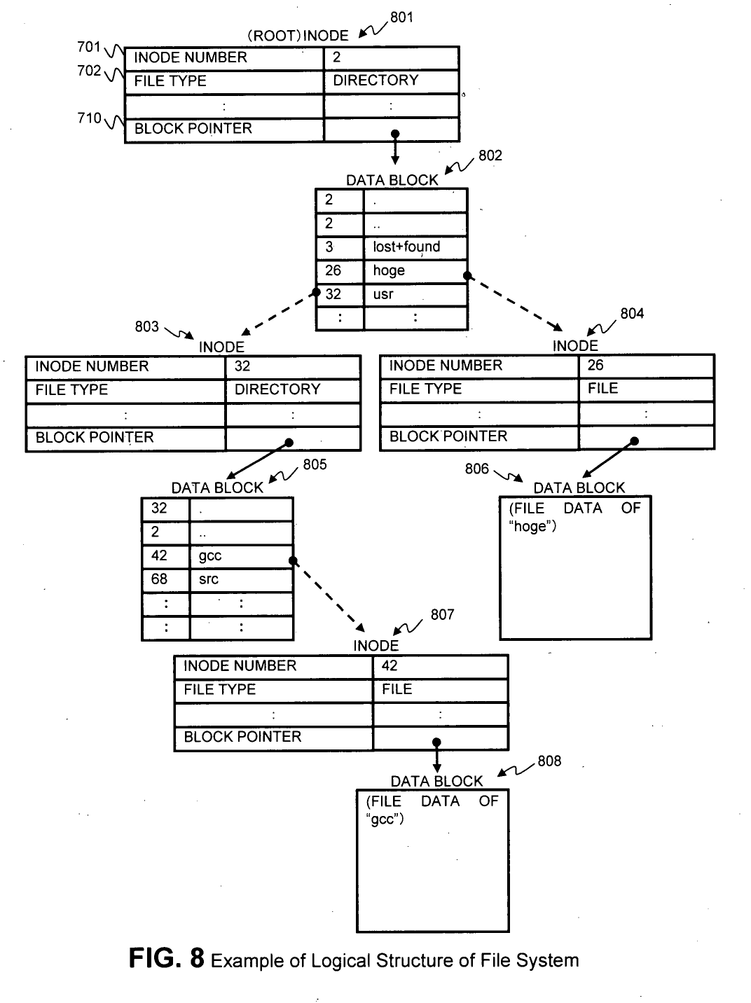

FIG. 8 illustrates the logical relationship between inodes 609 and data blocks 608. Each inode 609 can be used to indicate a file or a directory. If the inode indicates a file (i.e., if its file type field 702 is “file”, such as is indicated at 804 and 807), then the data blocks 608 pointed from block pointer 710 in the inode contains actual data of the file. For example, if a file is stored in a plurality of data blocks 608, such as ten data blocks, then addresses of the ten data blocks 608 are recorded in block pointer 710. On the other hand, if the inode indicates a directory (i.e., if the file type field 702 is “directory”, such as is indicated at 801 and 803), then the data blocks 608 pointed to from block pointer 710 in the inode store a list of inode numbers 701 and names of all files and sub-directories that resides in the directory (this list is called a directory entry). Super block 603, block group descriptor 604, data block bitmap 605, inode bitmap 606, and inode table 607 are initialized when file system data 210 is created in a volume.

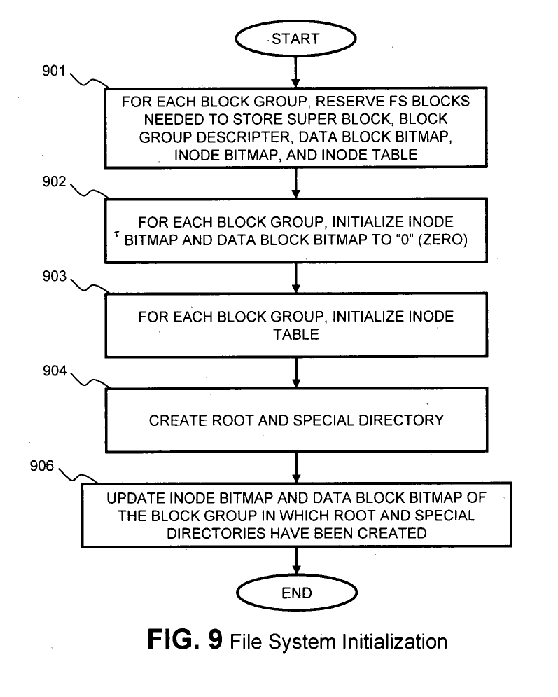

FIG. 9 illustrates a flowchart of an example of a process for initializing file system data 210, as carried out by file system module 202.

Step 901: For each block group 602, file system module 202 reserves sufficient FS blocks 600 needed to store super block 603, block group descriptor 604, data block bitmap 605, inode bitmap 606, and inode table 607.

Step 902: For each block group 602, file system module 202 initializes inode bitmap 606 and data block bitmap 605 to zero.

Step 903: For each block group 602, file system module 202 initializes inode table 607.

Step 904: File system module 202 creates the root directory (/) and the special directory (lost+found).

Step 905: File system module 202 updates inode bitmap 606 and data block bitmap 605 of the block group 602 in which the root and special directory have been created.

When a file or directory is created, file system module 202 searches for free inodes 609 in reference to inode bitmap 606. Starting from the first block group 602, file system module 202 tries to acquire an inode 609. Then, file system module 202 adds the information of the new file or directory to the found inode 609, and adds the name of the new file or directory and inode number 701 of the new inode 609 for the new file or directory to the directory entry of the directory under which the new file or directory is created. Also, file system module 202 changes the corresponding bit of the inode 609 in inode bitmap 606 to “1”, which indicates “in use”.

When new data is added to a file, file system module 202 searches for free data blocks 608 in reference to data block bitmap 605. Then, file system module 202 adds a pointer to the found data blocks 608 to the inode 609 of the file, and writes the new data to the found data blocks 608. Also, file system module 202 changes the corresponding bit of the data blocks 608 in data block bitmap 605 to “1” (in use). When a file or a directory is deleted, file system module 202 deletes the information (i.e., name and inode number 701) of the file or directory from the directory entry of the directory under which the file or directory resided. Also, file system module 202 changes the corresponding bits in inode bitmap 606 and data block bitmap 605 to “0”, which indicates “free”.

Alignment Between File System Blocks and Segments

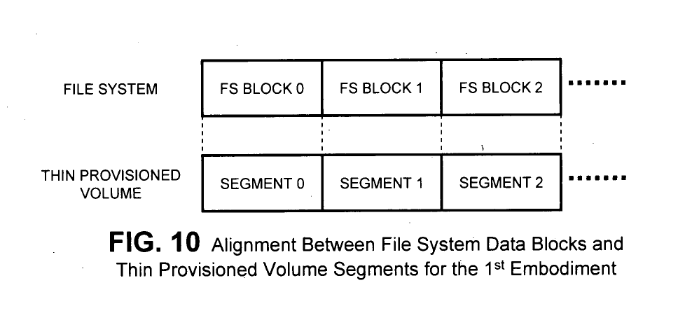

As described above, file system module 202 on NAS controller 101 divides a volume into FS blocks 600, and thin provisioning manager 204 on disk array system 201 divides a TPV 207 into segments 302. In the first embodiments of the invention, the size of each FS block 600 and that of each segment 302 are made to be the same, and can be aligned as illustrated in FIG. 10, such that there is a one-to-one correspondence between FS blocks and segments. In this case, a segment 302 can be released when its corresponding FS block 600 becomes “free”. For example, if a file system block is 4 kB in size, then the thin provisioning system may be set up so that each segment is 4 kB in size, and each chunk is also 4 kB in size. This arrangement of the first embodiments can simplify the management of using a NAS with a thin provisioning storage system because as a file system block is no longer being used, the NAS can notify the thin provisioning storage system that the corresponding segment is no longer used and the corresponding chunk can be released.

Procedure of Deleting a File on the File System:

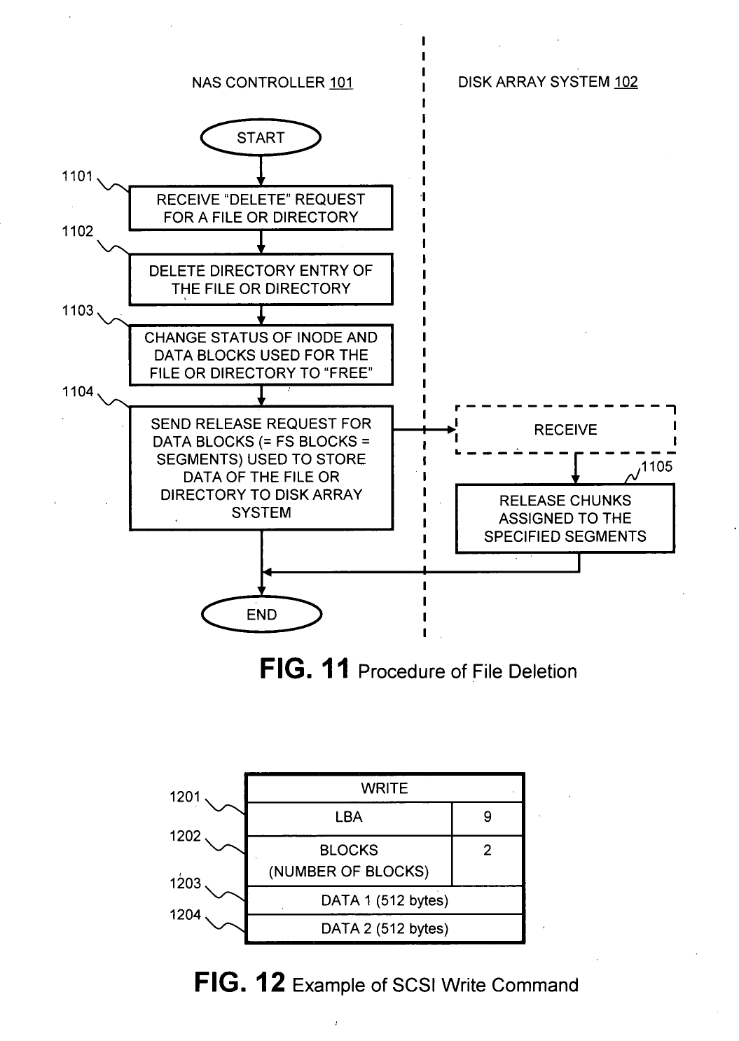

In the first embodiment, NAS controller 101 informs disk array system 201 when FS blocks 600 (which can be directly equated to segments 302) become free or no longer used. That is, when a file or directory is deleted, file system module 202 on NAS controller 101 determines which FS blocks 600 are no longer being used, determines the corresponding segments 302 that are no longer being used to store data of the file or directory, and provides this information to disk array system 201. In response to this notification, disk array system 201 releases one or more chunks 301 which correspond to any segments 302 that are no longer used. FIG. 11 illustrates an example of a process carried out in the first embodiment of the invention when deleting file system data.

Step 1101: File system module 202 on NAS controller 101 receives a request for deleting a file or directory.

Step 1102: File system module 202 deletes the information for the file or directory from the directory entry of the directory under which the file or directory resided.

Step 1103: File system module 202 changes the usage status of inode 609 and data blocks 608 that had been used to store data of the file or directory to “free”. As described above, the usage status of inode 609 and data blocks 608 are stored in inode bitmap 606 and data block bitmap 605, respectively.

Step 1104: File system module 202 sends a “release” request for the data blocks 608 (FS blocks 600=segments 302) that had been used to store the data of the deleted file. Additional details of the release request are described below.

Step 1105: Thin provisioning manager 204 on disk array system 102 changes the status of the segments 302 to “0” (i.e., not allocated) in TPV management table 205, and changes the status of the chunks 301 that had been assigned to the segments 302 to “0” (i.e., free) in pool management table 206. As described above, the status of segments 302 and chunks 301 are stored in TPV management table 205 and pool management table 206, respectively.

Implementation of Release Request from NAS Controller to Disk Array System

The release request from NAS controller 101 to disk array system 201 can be implemented in various ways in the embodiments of the invention. For example, the release request can be implemented as a newly-defined command on a newly-defined interface. However, in order to utilize an existing interface, a standard SCSI command may be used, as illustrated in FIG. 12. For instance, a Write command of the conventional SCSI standard contains a logical block address (LBA) 1201, blocks 1202 (number of blocks to be written), and data (data to be written) 1203 and 1204 as its parameters. Utilizing this command, the release request can be implemented as a Write command with predetermined special data. For example, if DATA1 1203 is filled with special data such as “0xdeadbeaf”, disk array system 201 can recognize the command as a release command. When Write command of SCCI standard is used for the release request, LBA 1201 can be used to specify which segment 302 is to be released, and blocks 1202 can be a predetermined or arbitrary number. Correlation between the LBA and offset in TPV are managed by file system module 202 in a conventional manner. For example, if each logical block in a disk array system is 512 bytes in size, and each FS block is 4096 bytes in size, then the 1 st FS block starts from LBA 0, and the 2nd FS block starts from LBA 8, and so forth. Applying this example to the first embodiment, if the 2nd FS block is no longer being used then the corresponding segment needs to be released. The file system module 202 correlates the offset of the FS block with the LBA and then specifies the segment to be released by, for example, its starting LBA (i.e., LBA 8) in the SCSI write command. Of course, it is understood that the sizes of logical blocks and FS blocks can vary from system to system, with the foregoing explanation merely being an example.

### SECOND EMBODIMENT

Having the segment size equal to the file system block size, as discussed for the first embodiment, can simplify management of the thin provisioning segments that are no longer being used because segments (and corresponding chunks) can be released as soon as a corresponding FS block is no longer used. However, because file system blocks are typically relatively small in size, this arrangement can result in a very large number of segments and chunks to keep track of in the thin provisioning disk array storage system, thereby increasing overhead and slowing performance in the disk array system. In the second embodiment, to reduce this overhead, the size of each segment 302 is larger than the size of each FS block 600. For example, the size of a FS block 600 might be 4 kB, while the size of a segment 302 might be 32 MB, so that 8192 FS blocks 600 would fit in a single segment 302. Other sizes for the FS blocks and segments may also be used, with it being understood that the above sizes are just an example. Thus, under the second embodiment, multiple FS blocks 600 will fit into one segment 302, and for explanation purposes, it will be assumed that the number of FS blocks 600 that fit into one segment 302 is “M”.

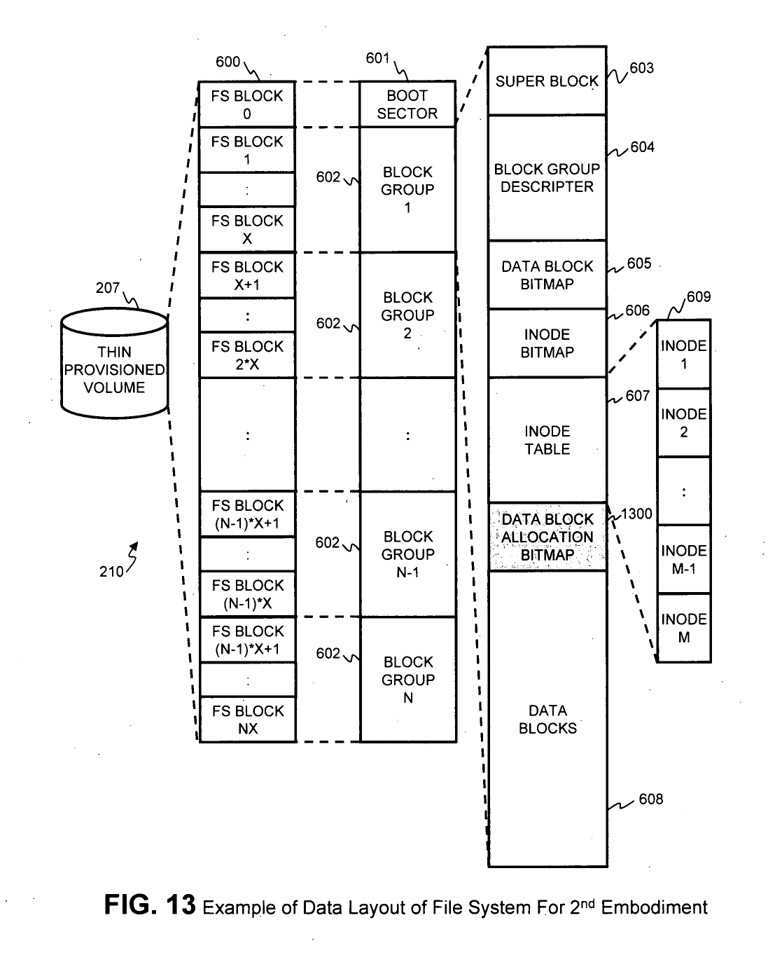

In the second embodiment, a chunk 301 allocated to a segment 302 can be released only when there is no used FS block 600 within the entire segment 302. Since, as illustrated in FIG. 13, the first several FS blocks 600 in each block group 602 are initialized for the regions such as super block 603, block group descriptor 604, data block bitmap 605, inode bitmap 606, and inode table 607 when file system data 210 is created, chunks 301 will be assigned to the segments 302 corresponding to the first several FS blocks 600 in each block group 602 upon creation of file system data 210. However, since data blocks 608 will not be initialized, no chunks 301 will be assigned to the segments 302 corresponding to data blocks 608. Therefore, in the second embodiment, file system module 202 manages the usage status of data blocks 608, and the correspondence between data blocks 608 and segments 302. The second embodiment may be implemented using the same system configuration as the first embodiment described above with respect to FIG. 1, and using the same software modules as described above.

Alignment Between File System Data Blocks and Segments

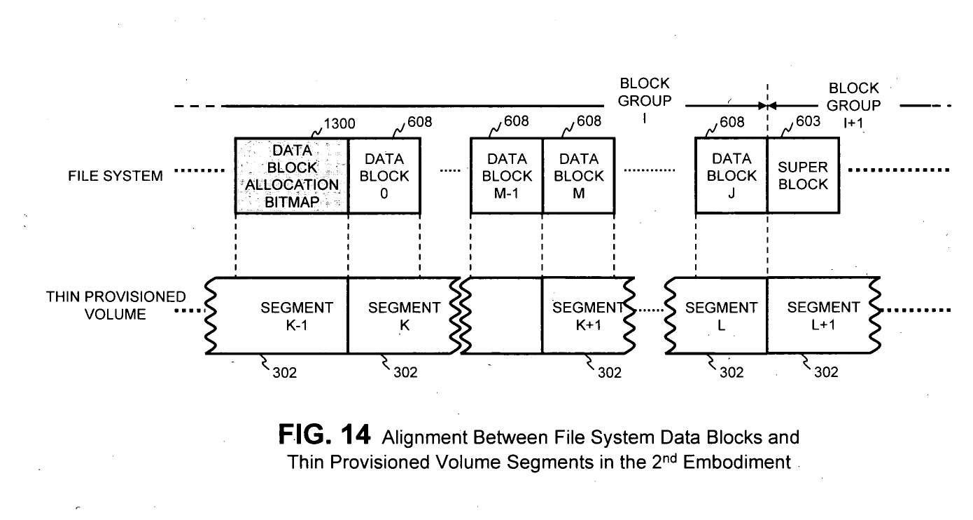

In this embodiment, data blocks 608 are aligned with segments 302 as illustrated in FIG. 14, such that there is a many-to-one correspondence between the data blocks and each segment. That is, the start LBA of data block 0 in each block group 602 is the same as the start LBA of a segment 302. For example, in FIG. 14, the start LBA of data blocks 608 of block group “I” is the same as the start LBA of segment “K”. File system module 202 manages the usage status of the data blocks 608 using a data block allocation bitmap 1300, as also illustrated in FIG. 13, and as also described below.

File System Data Structure

In second embodiment, the data block allocation bitmap 1300 is included within each block group 602 in file system data 210, as illustrated in the data structure of the file system data in FIG. 13. Data block allocation bitmap 1300 is used to manage to which data blocks 608 chunks 301 are assigned. In other words, data block allocation bitmap 1300 is used to determine whether a data block 600 has actual disk space currently allocated to it. Like data block bitmap 605, each bit in the data block allocation bitmap 1300 corresponds to each data block 608. For example, the third bit in the bitmap 1300 corresponds to the third data block in the block group 602 in which the bitmap 1300 is located, and each bit in bitmap 1300 represents the allocation status of the data block 608, for instance, a “0” (not allocated) indicates the data block does not have actual disk space, and a “1” (allocated) indicates the particular data block has actual disk space allocated to it. Additional details of the procedure carried out using data block allocation bitmap 1300 for correlating data blocks in a block group with allocation status will be explained hereinafter.

Procedure of Selecting Data Blocks on File System

As described above, file system module 202 searches for free data blocks 608 when new data is to be added to a file or directory. When a data block 608 is selected, file system 202 changes the status of the corresponding bit in the data block bitmap 605 to “1” (i.e., in use). In the second embodiment, file system module 202 also changes status of the corresponding bit in the data block allocation bitmap 1300 to “1” (i.e., allocated) so that file system module 202 can manage which data blocks 608 have actual disk space already allocated (i.e., which data blocks 608 have already been used).

Here, since disk array system 102 allocates actual disk space (i.e., a chunk 301) by a unit of a segment 302, some neighboring data blocks 608 adjacent to the selected data block 608 will also have actual disk space allocated when a chunk 301 is allocated to a segment 302. File system module 202 calculates which neighboring data blocks 600 will also have actual disk space allocated, and changes the status of these neighboring data blocks 608 in the data block allocation bitmap 1300 at the same time. Here, for example, if the data block P is selected (data block P corresponds to a (P+1)th data block based on the arrangement shown in FIG. 14), the neighbor data blocks 608 that will have actual disk space allocated at the same time can be identified using the following equations:

Start neighbor data block#=M*rounddown(P/M)

End neighbor data block#=M*{roundup(P/M)}−1

Here, “rounddown” means rounding down the result of the calculation in the parentheses to the nearest whole number, and “roundup” means rounding up the result of the calculation in the parentheses to the nearest whole number. As described above, M is the number of data blocks 608 that fit into one segment 302. According to the example sizes given above, if the size of a data block 608 is 4 kB and the size of a segment 302 is 32 MB, then M is equal to 8192. Of course, other sizes for the data blocks 608 and segments 302 may also be used, with it being understood that the above sizes and quantity for M are just an example for discussion.

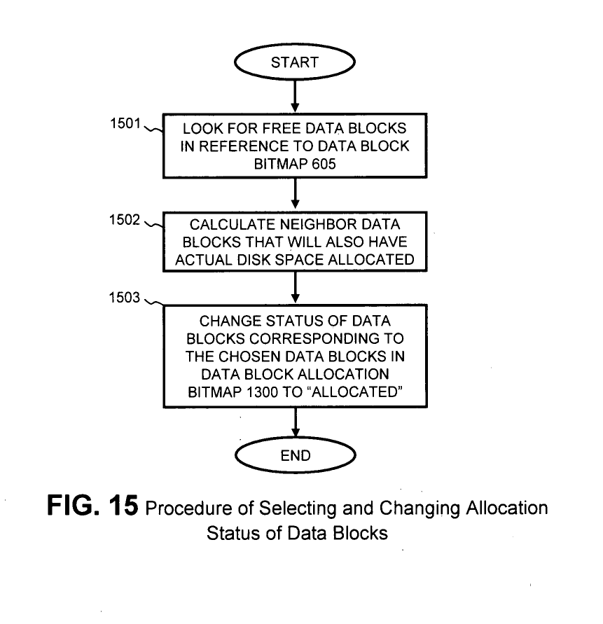

FIG. 15 illustrates a flowchart of a process for selecting and changing allocation status of data blocks 608 when data needs to be written to a file or directory in the block group.

Step 1501: File system module 202 on NAS controller 101 looks for free data blocks 608 by referring to data block bitmap 605.

Step 1502: File system module 202 calculates start and end of neighbor data blocks 608 that will have actual disk space allocated at the same time using the above equations.

Step 1503: File system module 202 changes the allocation status of selected data blocks 608 to “allocated” in the data block allocation bitmap 1300.

The remainder of the process of writing data to allocated data blocks is the same as described above in the first embodiment. File system module 202 adds a pointer to the data block 608 to the inode 609 of the file, changes the corresponding bit of the data block 608 in data block bitmap 605 to “1” (in use). File system module 202 writes the new data to the data block 608 by sending the data to the disk array system using a Write command with a LBA that matches the number of the data block 608. In the disk array system, the segment 302 that corresponds to the LBA in the TPV is assigned a chunk 301 from the chunk pool 209, the allocation status of the segment 302 is changed to “1” (allocated) in TPV management table 205, and the usage status of the chunk 301 is changed to “1” (in use) in the pool management table 206. The data sent from the NAS controller is stored by the disk array system in the corresponding segment 302 and assigned chunk 301.

Procedure of Releasing Unused Segments

In the second embodiment, NAS controller 101 informs disk array system 201 when any segments 302 are no longer being used, i.e., when data in all the data blocks 608 in a segment 302 has been deleted. This procedure can be carried out periodically, or it can be carried out every time a file or directory is deleted.

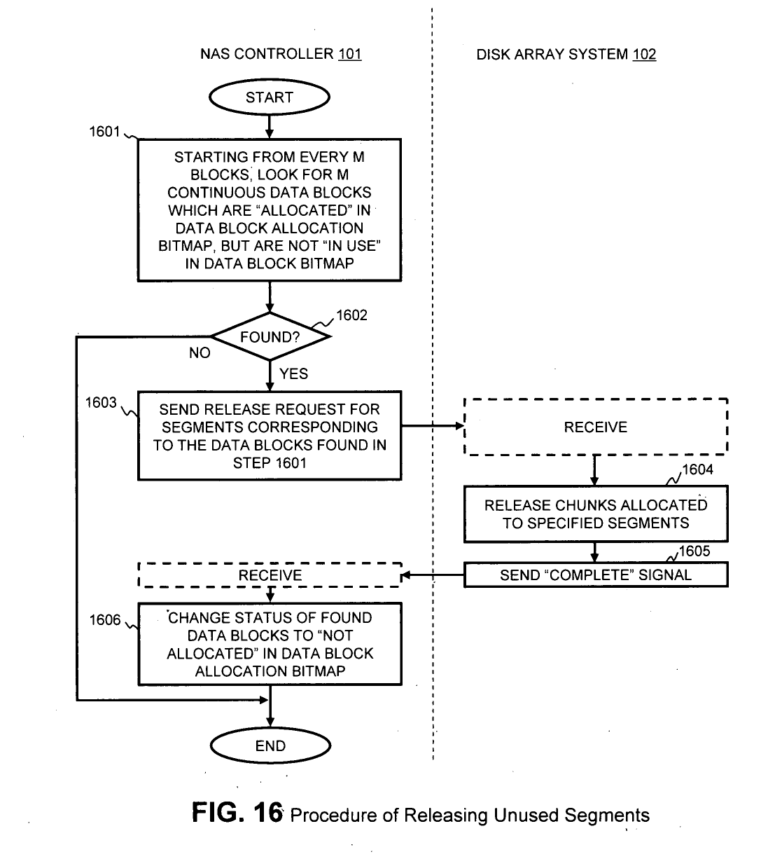

FIG. 16 illustrates a flowchart of a process for releasing unused segments 302 in the second embodiment.

Step 1601: Starting from every M data blocks in each block group 602 (which corresponds to the start LBA for a next segment), file system module 202 on NAS controller 101 looks for M successive data blocks 600 which are “1” (allocated) in data block Allocation Bitmap 1300, but all of which are “0” (free) in data block bitmap 605.

Step 1602: When file system module 202 locates M such successive data blocks that meet the conditions in step 1601, the process goes to Step 1603. Otherwise, there are no segments to release, and the process ends.

Step 1603: File system module 202 sends a release request to the disk array system for the segment found in Step 1601. The release request may be implemented in the same way as described above for the first embodiment. For example, the release request may take the format of a SCSI Write command, as discussed above with respect to FIG. 12, and may specify the start LBA of the segment to be released.

Step 1604: A disk array system 102, thin provisioning manager 204 determines the chunk 301 that corresponds to the specified segment 302, releases the specified segment by changing allocation status 403 in TPV management table 205 to “0” (not allocated), and returns the corresponding chunk 301 to its pool volume 208 by changing usage status 503 in pool management table 206 to “0” (free).

Step 1605: Thin provisioning manager 204 sends a “complete” signal back to NAS controller 101.

Step 1606: File system module 202 changes status of the found data blocks to “0” (not allocated) in data block allocation bitmap 1300, and ends the process.

### THIRD EMBODIMENT

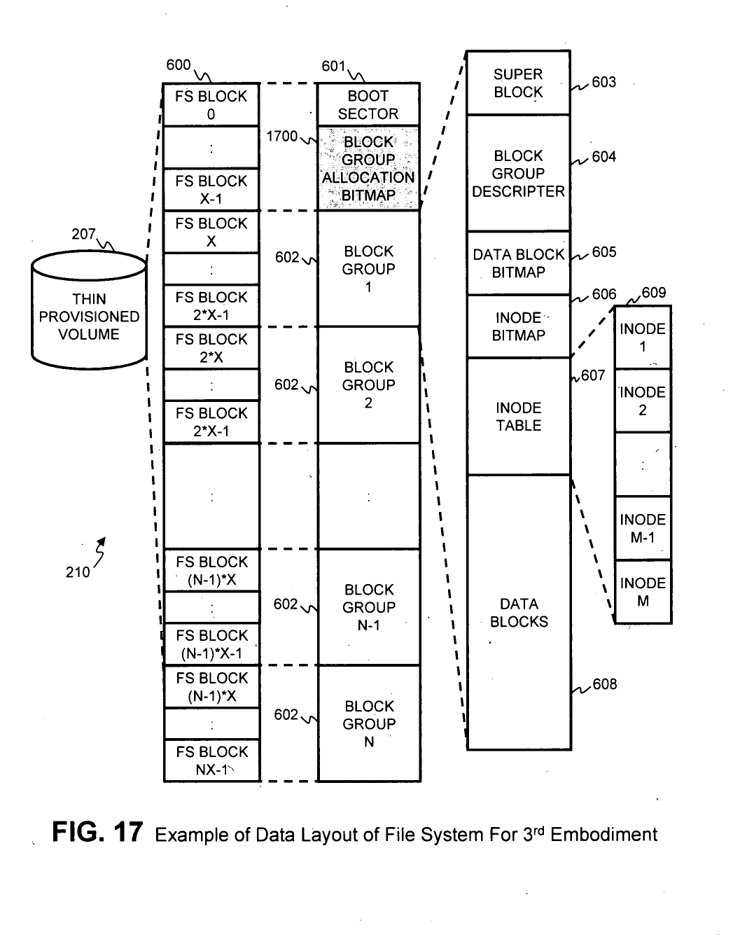

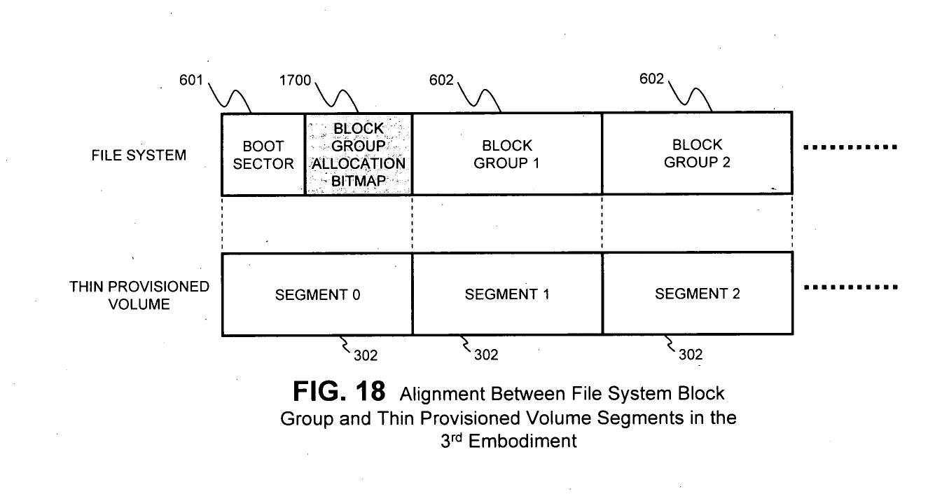

In the third embodiment, as in the second embodiment, the size of each FS block 600 is smaller than the size of each segment 302 is considered. In the third embodiment, the size of each block group 602 is the same as the size of each segment 302. In this case, a block group allocation bitmap 1700 can be included in the data structure of the file system data, as illustrated in FIG. 17, and the block groups 602 can be aligned with segments 302 in TPV 207 as illustrated in FIG. 18, such that there is a one-to-one correspondence between block groups and segments. Thus, in the third embodiments, a chunk 301 allocated to a segment 302 can be released only when there is no used resource (e.g., inode 609, data block 608, etc.) within the particular block group 602 that corresponds to the particular segment 302. The third embodiment may be implemented using the same system configuration as the first and second embodiments described above with respect to FIG. 1, and using the same software modules as described above.

File System Data Structure

In the third embodiment, there is a block group allocation bitmap 1700 created in file system data 210 for each TPV 207. Block group allocation bitmap 1700 manages which block groups 602 have actual disk space allocated to them. Similar to data block bitmap 605 and data block allocation bitmap 1300, each bit in the block group allocation bitmap 1700 corresponds to the block group 602 having the same number. For example, a third bit in block group allocation bitmap 1700 corresponds to a third block group in the TPV 207 to which the file system data 210 is stored. Thus, each bit represents allocation status of the block group. For example, a “1” (i.e., allocated) indicates that the corresponding block group has actual disk space allocated to it, while a “0” (i.e., not allocated) indicates that the corresponding block group does not have actual disk space allocated to it yet.

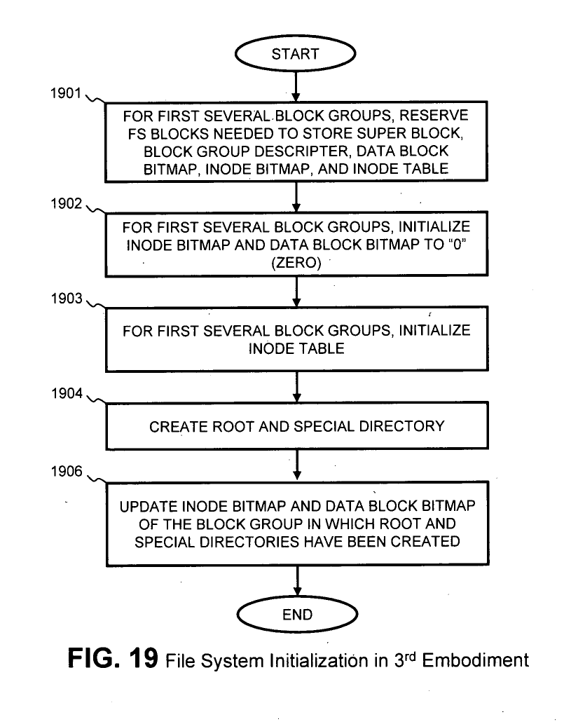

Also, as illustrated in FIG. 19, file system module 202 in the third embodiment only initializes the first several block groups 602 that will be needed to create the root (/) and special directory (lost+found) when the file system data 210 is created in a TPV 207. In other words, file system module 202 delays initialization of the rest of block groups 602 so that actual disk space will not be allocated to the rest of the block groups 602 until needed. The steps carried out during file system initialization are set forth in FIG. 19, and described below.

Step 1901: For the first several block groups 602, file system module 202 reserves FS blocks 600 needed to store super block 603, block group descriptor 604, data block bitmap 605, inode bitmap 606, and inode table 607. Here, disk array system 102 will assign a chunk 301 to the segments 302 corresponding to each of the first few block groups 602, since disk array system 102 will receive write I/O requests to the corresponding segments 302.

Step 1902: For the first several block groups 602, file system module 202 initializes inode bitmap 606 and data block bitmap 605 to “0” (zero).

Step 1903: For first several block groups 602, file system module 202 initializes inode table 607.

Step 1904: File system module 202 creates root (/) and special directory (lost+found).

Step 1905: File system module 202 updates inode bitmap 606 and data block bitmap 605 of the block group 602 in which root and special directory have been created. Thus, the first several block groups 602 are initialized to enable creation of the root and special directory. Additional block groups 602 do not have chunks allocated until they are needed.

Procedure of Allocating Resources on File System

As described above, file system module 202 searches for resources (inodes 609 and data blocks 608) as needed. Starting from the first block group 602, file system module 202 tries to acquire required resources. In this embodiment, file system module 202 tries to acquire resources from block groups 602 that are already in use as much as possible. When there are not enough resources in the block groups that already have chunks allocated to them, then the file system module 202 initializes the next block group 602.

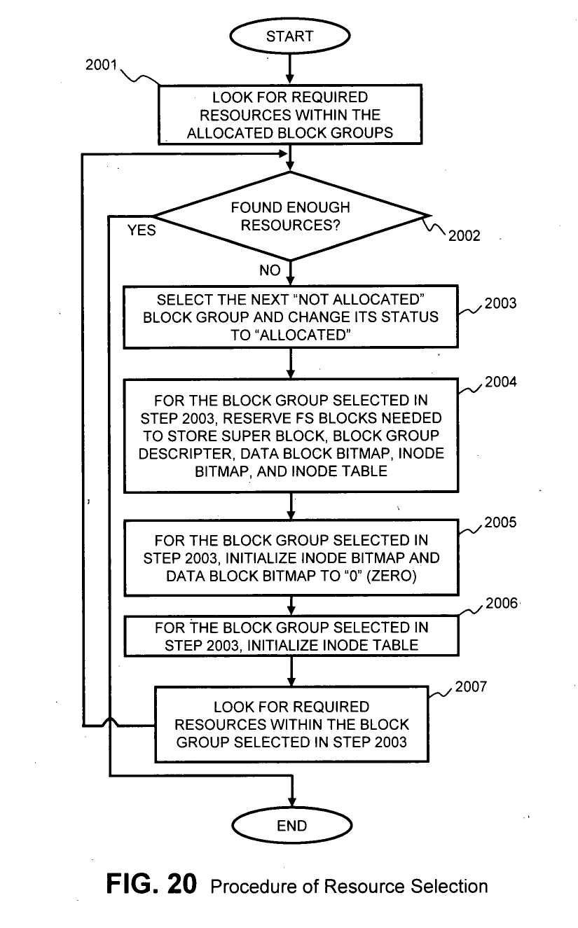

FIG. 20 illustrates a flowchart of a process for acquiring resources (e.g., inodes 609 and data blocks 608).

Step 2001: File system module 202 on NAS controller 101 searches for free resources within allocated block groups in reference to block group allocation bitmap 1700, data block bitmap 605, and inode bitmap 607.

Step 2002: File system module 202 makes a check to determine whether enough resources have been found or not. If yes, the process ends and uses those resources. Otherwise, the process goes to Step 2003.

Step 2003: File system module 202 changes the status of the next “not allocated” block group 602 to “allocated” in block group allocation bitmap 1700.

Step 2004: For the block group 602 selected in step 2003, file system module 202 reserves FS blocks 600 needed to store super block 603, block group descriptor 604, data block bitmap 605, inode bitmap 606, and inode table 607. Here, disk array system 102 will assign a chunk 301 to the next segment 302 corresponding to the next block group 602, since disk array system 102 will receive a write I/O request to the next segment 302.

Step 2005: For the block group 602 selected in step 2003, file system module 202 initializes inode bitmap 606 and data block bitmap 605 to “0” (zero).

Step 2006: For the block group 602 selected in step 2003, file system module 202 initializes inode table 607.

Step 2007: File system module 202 looks for required resources in the newly allocated block group 602, and proceeds back to Step 2002 to determine if enough resources are found.

Procedure of Releasing Unused Chunks

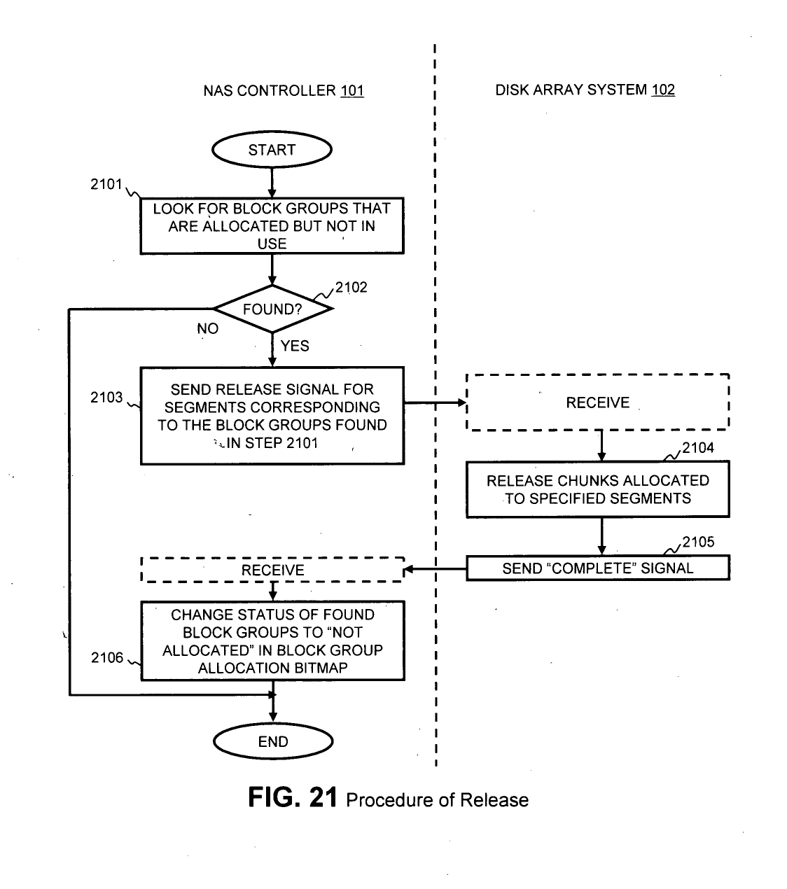

In the third embodiment, NAS controller 101 informs disk array system 102 when segments 302 become unused by carrying out the procedure set forth in FIG. 21. This procedure can be carried out periodically, or can be carried out every time that a file or directory is deleted. FIG. 21 illustrates a flowchart of the process for releasing unused segments 302, as also described below.

Step 2101: File system module 202 on NAS controller 101 searches for block groups 602 that are allocated according to block group allocation bitmap 1700, but that are not in use (i.e., no resources in them are in use) according to data block bitmap 605 and inode bitmap 606.

Step 2102: If file system module 202 finds any block groups 602 in step 2101, the process goes to Step 2103. Otherwise, if no block groups are found in Step 2101, there are no chunks to be released and the process ends.

Step 2103: File system module 202 sends a release request to the disk array system 102 for the block group 602 (=segment 302) found in Step 2101. The release request may be implemented in the same way as described above for the first and second embodiments. For example, the release request may take the format of a SCSI Write command, as discussed above with respect to the FIG. 12, and may specify the start LBA of the segment to be released.

Step 2104: Thin provisioning manager 204 on disk array system 102 releases the chunks 301 assigned to the segments 302.

Step 2105: Thin provisioning manager 204 sends a “complete” signal to the NAS controller.

Step 2106: File system module 202 changes the status of the found block groups 602 to “not allocated” in block group allocation bitmap 1700, and ends the process.

In a variation of the third embodiment, the segments are not necessarily in a one-to-one correspondence with the block groups. Instead, multiple block groups may correspond to a single segment in the thin provisioned volume, or two or more segments might correspond to a single block group. Other variations will also be apparent to those of skill in the art in view of the present disclosure. Thus, it may be seen that the invention provides for utilizing disk space more efficiently when a disk array system having thin provisioning capability is used in conjunction with a NAS system. FS blocks or block groups no longer in use on the NAS system are identified by the NAS system. The NAS system sends a release request to the disk array system specifying thin provisioning segments that correspond to the identified FS blocks or block groups. The release request instructs the disk array system to release chunks of physical storage assigned to the specified thin provisioning segments so that the chunks can be reused in the disk array storage system.

From the foregoing, it will be apparent that the invention provides methods and apparatuses for enabling a NAS system to use thin provisioning technology. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the above description has been made in an illustrative fashion, and not a restrictive one. Accordingly, the scope of the invention should properly be determined with reference to the appended claims, along with the full range of equivalents to which such claims are entitled.

What is claimed is:

1. An information system comprising:
a disk controller in communication with one or more storage devices;
a thin provisioned volume presented by said disk controller as a storage resource for storing file system data, said thin provisioned volume being logically divided into a plurality of storage segments, wherein said disk controller is configured to allocate physical storage capacity from said one or more storage devices to a particular one of said segments for which the physical storage capacity is not already allocated when the particular segment is first targeted for storing the file system data; and
a file system module in communication with said disk controller for accessing the thin provisioned volume, wherein said file system module is configured to send a release request to said disk controller when the file system data corresponding to the particular segment has been deleted, said release request instructing the disk controller to release the physical storage capacity allocated to the particular segment.

2. An information system according to claim 1, further comprising:
a network attached storage (NAS) controller in communication with said disk controller, said file system module running on said NAS controller and managing the file system data.

3. An information system according to claim 2, further comprising:
a file server running on said NAS controller, said file server being in communication with a NAS client,
wherein said file server is configured to receive file data from said NAS client, and pass the file data to the file system module,
wherein the file system module is configured to determine file system blocks for storing the file data and correlate the file system blocks with a logical block address of the thin provisioned volume,
wherein the disk controller is configured to assign physical storage capacity to a segment of said plurality of segments that corresponds to the logical block address when physical storage capacity is not already assigned, and store the file data in the assigned physical storage capacity.

4. An information system according to claim 2,
wherein said file system module is configured to divide the file system data into a plurality of file system blocks,
wherein there is a one-to-one correspondence between said file system blocks and said segments in the thin provisioned volume, and
wherein, when one of the file system blocks is identified as being no longer in use by the file system module, the file system module is configured to send the release request to the storage controller to instruct release of the physical storage capacity assigned to one of the segments corresponding to the identified file system block.

5. An information system according to claim 2,
wherein said file system module is configured to divide the file system data into a plurality of block groups, each block group including a plurality of data blocks for storing file data, wherein a predetermined number of data blocks in a block group correspond to one of said segments in said thin provisioned volume, and
wherein, when physical storage capacity has been assigned to the segment corresponding to said predetermined number of data blocks and all of said predetermined number of data blocks are no longer in use by the file system module, said file system module is configured to send the release request to the storage controller to instruct release of the physical storage capacity assigned to the segment corresponding to said predetermined number of data blocks.

6. An information system according to claim 2,
wherein said file system module is configured to divide the file system data into a plurality of block groups made up of file system blocks for storing file data, wherein each block group corresponds to one of said segments in said thin provisioned volume, and
wherein, when physical storage capacity has been assigned to one of said segments corresponding to one of said block groups and said one of said block groups is no longer in use by the file system module, said file system module is configured to send the release request to the storage controller to instruct release of the physical storage capacity assigned to the segment corresponding to said one of said block groups.

7. An information system according to claim 1, further comprising:
a pool volume, said pool volume being a logical volume allocated from the physical storage capacity on said one or more storage devices, said pool volume being divided into a plurality chunks of physical capacity,
wherein said disk controller is configured to assign one of said chunks to one of said segments to provide the physical storage capacity for said one of said segments, and is further configured to release said one of said chunks from said one of said segments in response to a release request identifying said one of said segments received from said file system module.

8. An information system according to claim 1, further comprising:
one or more bitmaps maintained in the NAS system for keeping track of data blocks or block groups created by the file system module that have said segments allocated thereto.

9. A method of operating an information system including a network attached storage (NAS) controller in communication with a disk array system, comprising:
providing a first volume by the disk array system for storing a file system, said first volume being logically divided into a plurality of segments, wherein physical storage capacity is not assigned to a particular segment of the first volume until the particular segment of the first volume is first targeted for storing data;
identifying file system blocks or block groups no longer in use by the NAS controller, said file system blocks or block groups having been used by the NAS controller to store file system data in the first volume; and
sending a release request to the disk array system specifying one or more of said segments that correspond to the identified file system blocks or block groups, the release request instructing the disk array system to release the physical storage capacity assigned to the specified one or more segments so that the physical storage capacity is available for reuse in the disk array system.

10. A method according to claim 9, further including steps of
providing a file server running on said NAS controller, said file server being in communication with a NAS client;
receiving file data from said NAS client, and passing the file data to a file system module running on said NAS controller;
determining, by the file system module, file system blocks for storing the file data and correlating the file system blocks with a logical block address of the thin provisioned volume; and
assigning, by the disk array system, physical storage capacity to the segment corresponding to the logical block address when physical storage capacity is not already assigned, and storing the file data in the assigned physical storage capacity.

11. A method according to claim 9, further including steps of
receiving file data at the NAS controller for storage in the disk array system; and
identifying a plurality of file system blocks in the file system to be used for storing the file data,
wherein there is a one-to-one correspondence between said file system blocks and said segments in the first volume,
wherein, when one of said file system blocks, is identified as no longer being used by the NAS controller, the release request is sent from the NAS controller to the disk array system to instruct release of the physical storage capacity assigned to the segment corresponding to the identified file system block.

12. A method according to claim 9, further including steps of
receiving file data at the NAS controller for storage in the disk array system; and
identifying a plurality of data blocks in the file system to be used for storing the file data,
wherein a data structure of the file system includes a plurality of block groups, each block group including a plurality of the data blocks for storing the file data, wherein a predetermined number of data blocks in a block group correspond to one of said segments in said first volume,
wherein, when physical storage capacity has been allocated to the segment corresponding to said predetermined number of data blocks and all of said predetermined number of data blocks are no longer in use by the NAS controller, said NAS controller sends the release request to the disk array system to instruct release of the physical storage capacity assigned to the segment corresponding to said predetermined number of data blocks.

13. A method according to claim 9, further including steps of
receiving file data at the NAS controller for storage in the disk array system; and
identifying a plurality of data blocks in the file system to be used for storing the file data,
wherein a data structure of the file system includes a plurality of block groups, each block group including a plurality of the data blocks for storing the file data, wherein each block group corresponds to one of said segments in said first volume,
wherein, when physical storage capacity has been allocated to one of said segments corresponding to one of said block groups and said one of said block groups is no longer in use by the NAS controller, said NAS controller sends the release request to the disk array system and identifies the segment corresponding to said one of said block groups.

14. A method according to claim 9, further including a step of
maintaining one or more bitmaps in the NAS controller for keeping track of data blocks or block groups created by the NAS controller that have said segments allocated thereto.

15. An information system comprising:
a NAS (network attached storage) controller in communication with a disk controller, said disk controller being in communication with one or more storage devices;
a thin provisioned volume presented by said disk controller as a storage resource to the NAS controller for storing file system data, said thin provisioned volume being logically divided into a plurality of storage segments, wherein said disk controller allocates physical storage capacity from said one or more storage devices to a particular one of said segments for which the physical storage capacity is not already allocated when the particular segment is first targeted for storing the file system data; and
a file system module at said NAS controller configured to create a file system and issue (input/output) I/O requests for storing data of the file system to the thin provisioned volume in the disk array system.

16. An information system according to claim 15, further comprising:
a file server running on said NAS controller, said file server being in communication with a NAS client,
wherein said file server is configured to receive file data from said NAS client, and pass the file data to a file system module running on said NAS controller,
wherein the file system module is configured to determine file system blocks for storing the file system data and correlate the file system blocks with a logical block address of the thin provisioned volume,
wherein the disk controller is configured to assign physical storage capacity to a segment of said plurality of segments corresponding to the logical block address when physical storage capacity is not already assigned, and store the file data in the assigned physical storage capacity.

17. An information system according to claim 15,
wherein said NAS controller is configured to divide the file system data into a plurality of file system blocks,
wherein there is a one-to-one correspondence between said file system blocks and said segments in the thin provisioned volume, and
wherein when the file system data in an identified file system block is deleted, the NAS controller is configured to send the release request to the storage controller to instruct release of the physical storage capacity assigned to the one of the segments that corresponds to the identified file system block.

18. An information system according to claim 15,
wherein said NAS controller is configured to divide the file system data into a plurality of block groups, each block group including a plurality of data blocks for storing file data, wherein a predetermined number of data blocks in a block group correspond to one of said segments in said thin provisioned volume, and
wherein, when physical storage capacity has been assigned to the segment corresponding to said predetermined number of data blocks and all of said predetermined number of data blocks are no longer in use by the NAS controller, said NAS controller is configured to send the release request to the storage controller to instruct release of the physical storage capacity assigned to the segment corresponding to said predetermined number of data blocks.

19. An information system according to claim 15,
wherein said file system module is configured to divide the file system data into a plurality of block groups made up of file system blocks for storing file data, wherein each block group corresponds to one of said segments in said thin provisioned volume, and
wherein, when physical storage capacity has been assigned to one of said segments corresponding to one of said block groups and said one of said block groups is no longer in use by the NAS controller, said NAS controller is configured to send the release request to the storage controller to instruct release of the physical storage capacity assigned to the segment corresponding to said one of said block groups.

20. An information system according to claim 15, further comprising:
one or more bitmaps maintained in the NAS system for keeping track of data blocks or block groups created by the NAS controller that have said segments allocated thereto.
